(19) United States
(12) Patent Application Publication
(10) Pub. No.: US 2019/0370627 A1
(43) Pub. Date: Dec. 5, 2019

(54) SYSTEM AND METHOD FOR MARKING AND IDENTIFYING AN OBJECT

(71) Applicant: ROYAL SQUARE INVESTMENTS CC, East London (ZA)

(72) Inventor: Andrew Charles KESSLER, East London (ZA)

(21) Appl. No.: 16/341,674

(22) PCT Filed: Oct. 16, 2017
(86) PCT No.: PCT/IB2017/056402

§ 371 Date: Apr. 12, 2019

(30) Foreign Application Priority Data
Oct. 14, 2016 (ZA) 2016/02554

(51) Int. Cl. G06K 19/08; G09F 3/00; G06F 16/903; G06T 7/90

(52) U.S. Cl. CPC G06K 19/086; G09F 3/0297; G09F 2003/0276; G06T 7/90; G06F 16/903

(57) ABSTRACT

The invention discloses a system for marking and identifying an object comprising at least one bio-mineralised structure having a mean maximum diameter of less than 500 μm distinctively associated with the object. Identifying means are provided to identify the bio-mineralised structure associated with the object and provides a data output regarding the bio-mineralised structure which can be interpreted against a database, thereby providing information on the object. The invention extends to a method of marking and identifying an object utilising the aforementioned components.

### FIELD OF THE INVENTION

This invention relates to a system and method for marking and identifying an object, and more particularly, but not exclusively, to a system and method to associate a distinct marker with an object, the marker providing information relating to the object and which information may be compared against a database.

### BACKGROUND TO THE INVENTION

Marking an object to provide information such as the origin or kind of such object is often required and has wide application in industry.

Various labelling and tracing systems have been proposed to date. These systems involve various ways in which a code, such as a paper label is secured to an object. The label/code is then read by an appropriate reader and the information on the label is interpreted or processed to, amongst others, identify the source or designate the kind of object.

A disadvantage of these labels is, however, that they become illegible through wear and tear, for purposes of reading and interpretation, and in some cases, are inadvertently separated from the object as they are separate components.

Other disadvantages of the current systems are that the preparation and reading of these tags are often difficult and very costly and are often conducted in a lab environment. These tags are also almost invariably subject to wear and tear which may affect its usefulness for reading and identification purposes. Many of these tags are furthermore environmentally unfriendly and may even be hazardous. Metal based tags are furthermore chemically reactive precluding them from use in many materials such as pharmaceuticals.

Bio-minerals are organic-inorganic composites formed by biological organisms. In multi-cellular organisms these materials are found in the hard tissue. In single cell organisms they are found in most environments including aquatic and terrestrial. Bio-minerals serve a variety of functions such as structural support, defence, feeding and in certain bacterial species even magnetoreception.

Many examples of bio-minerals have been identified and include phytoliths, coral sand and diatoms.

Diatoms are a major group of algae within the subset phytoplankton.

Diatoms are unicellular structures having skeletons or cell walls made of silica (hydrated silicon dioxide) called frustules. Diatoms are found in aquatic environments including fresh and marine waters and moist soils.

Diatoms persist almost indefinitely with minimal or even no damage to its structural integrity, and are edible and non-toxic.

Diatomaceous earth is a naturally occurring, soft, siliceous sedimentary rock composed entirely of diatom frustules and which can be easily crumbled into a fine powder and accordingly useful in an embodiment of the invention. The shape of the diatom is determined by its species and is easily visible under a light microscope.

Species-pure diatom material can be grown at industrial scale in large containers, or bioreactors. Diatoms are photosynthetic and can be grown at a high rate from sunlight, together with a medium similar to seawater enriched with a sugar.

### OBJECT OF THE INVENTION

It is an object of the present invention to provide a system and method for marking and identifying an object with which the above disadvantages could at least partially be overcome or alleviated or which may provide a useful alternative for known systems and methods for marking and identifying an object.

### SUMMARY OF THE INVENTION

According to a first aspect of the invention there is provided a system for marking and identifying an object comprising:
at least one bio-mineralised structure having a mean maximum diameter of less than 500 μm distinctively associated with the object;
identifying means for identifying said at least one bio-mineralised structure whilst being associated with the object; and
an output for providing data regarding said at least one bio-mineralised structure.

The invention further provides for the at least one bio-mineralised structure to be integral with the object or provided as a source material, such as a fine powder, in the manufacturing of the object.

The invention further provides for the at least one bio-mineralised structure to be provided as a plurality of different types of bio-mineralised structures each type having at least one distinctive characteristic and wherein each characteristic provides for a distinctive data output; and wherein a combination of different types of bio-mineralised structures are provided by the output as a code or codes.

A further aspect of the invention provides for the data to be provided by the output in the form of a symbol or character.

The invention further provides for the data or code to be interpreted against a database to provide details of the manufacturer, information designating the kind of the object or history of the object including owner history and the transfer of ownership.

A further aspect of the invention provides for the output to include software to interpret the data or code against the information contained in the database.

The invention yet further provides for the output to include a display screen or printout.

Yet further according to the invention there is provided for the respective distinctive characteristics of the bio-mineralised structures to be expressed as the shape, size or colour of the bio-mineralised structures; and wherein the colour is adaptable by a synthetic dye applied to the bio-mineralised structures.

The bio-mineralised structures may be chemically treated to alter their surface properties to aid in binding or incorporation to materials such as plastics.

The invention provides for the bio-mineralised structure to include any one or more of the group consisting of diatom, phytolith and coral sand or any combination thereof.

The invention further provides for the identifying means to include any one of the group consisting of:
a lensless microscope, light microscope, electron microscope and confocal microscope,
apparatus for measuring conductivity, and
apparatus for identifying natural or synthetic DNA sequences using polymerase chain reaction techniques.

Any one of the microscopes may further include a polarized filter to determine the colour of the bio-mineralised structure under said filter.

The invention further provides for the lensless microscope to be installed on a mobile device such as a webcam, smartphone or tablet.

According to a second aspect of the invention there is provided for a method of marking and identifying an object comprising the steps of:
associating at least one distinctive bio-mineralised structure having a mean maximum diameter of less than 500 μm with the object;
identifying said at least one bio-mineralised structure; and
providing an output of data regarding said at least one bio-mineralised structure.

The invention further provides for the step of associating the at least one bio-mineralised structure with the object to further include the step of providing the at least one bio-mineralised structure as integral with the object or as a source material, such as a fine powder, in the manufacturing of the object.

The invention further provides for the at least one bio-mineralised structure to be provided as a plurality of different types of bio-mineralised structures each type having at least one distinctive characteristic and wherein each characteristic provides for a distinctive data output; and wherein a combination of different types of bio-mineralised structures are provided by the output as a code or codes.

A further aspect of the invention provides for the data to be provided by the output in the form of a symbol or character.

The invention further provides for the data or code to be interpreted against a database to provide details of the manufacturer, information designating the kind of the object or history of the object including owner history and the transfer of ownership.

The invention yet further provides for the output to include a display screen or printout.

Yet further according to the invention there is provided for the respective distinctive characteristics of the bio-mineralised structures to be expressed as the shape, size or colour of the bio-mineralised structures; and wherein the colour is adaptable by a synthetic dye applied to the bio-mineralised structures.

Further according to the invention there is provided for the step of associating at least one distinctive bio-mineralised structure with the object, includes the step of chemically treating the bio-mineralised structure to alter their surface properties to aid in binding or incorporation to materials such as plastics.

The bio-mineralised structure may include any one or more of the group consisting of diatom, phytolith and coral sand or any combination thereof.

The invention further provides for the step of identifying the at least one bio-mineralised structure to include any one of the group consisting of:
viewing the bio-mineralised structure through a microscope,
determining the conductivity of the object to detect the presence of the bio-mineralised structure,
employing polymerase chain reaction techniques to identify natural or synthetic DNA sequences within the bio-mineralised structure.

The invention further provides for viewing the bio-mineralised structure through a microscope to include the further step of using a polarized filter to determine the colour of the bio-mineralised structure under said filter. Microscope may include a lensless microscope, light microscope, electron microscope and confocal microscope.

The lensless microscope may be installed on a mobile device such as a webcam, smartphone or tablet.

Yet further according to the invention there is provided for identifying the bio-mineralised structure by a microscope to include the further step of providing photographic images from the microscope to be processed by software to identify and interpret the bio-mineralised structure against the information contained in the database.

### BRIEF DESCRIPTION OF THE DRAWINGS

The invention will now be described further by way of a non-limiting example with reference to the accompanying drawings wherein:

FIG. 1: shows a plurality of bio-mineralised structures in the form of diatoms through a light microscope;

FIG. 2: illustrates a diagrammatic representation of a number of strains prepared; and

FIG. 3: is a diagrammatic representation of the strains of FIG. 2 arranged in a sample code A and B according to the invention.

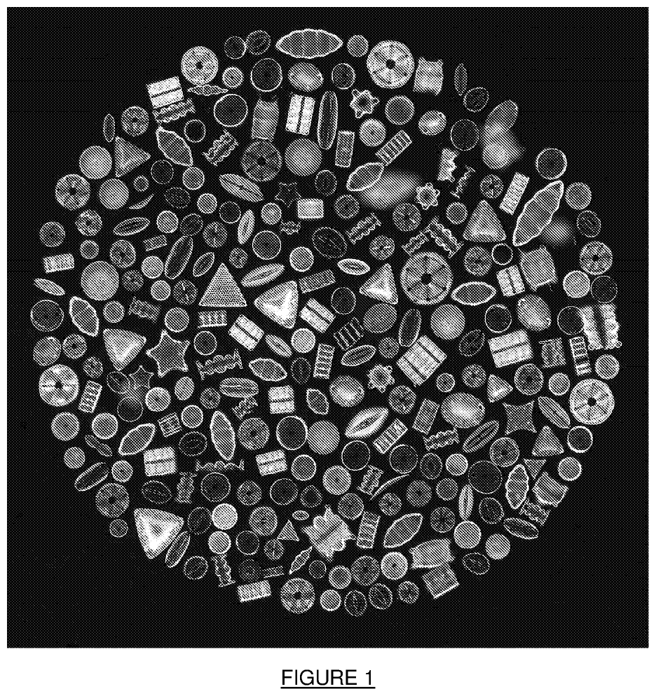

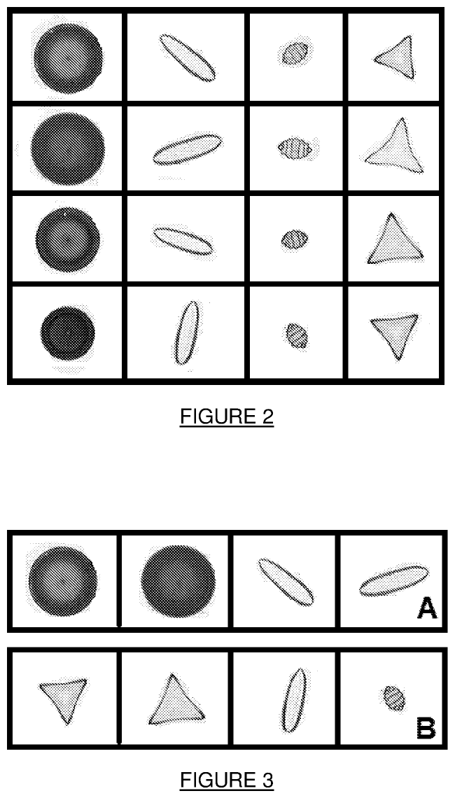

### DESCRIPTION OF PREFERRED EMBODIMENTS OF THE INVENTION

The invention discloses the use of bio-mineralised structures in a system and method to mark an object, and using means to identify and trace the origin of said object. This information may be read against information contained on a database.

In this embodiment a diatom is provided as the bio-mineralised structure which will be used to illustrate the invention. Many other bio-mineralised structures, such as phytolith and coral sand and combinations thereof may also be used without departing from the scope of the current invention. The mean maximum diameter of these structures will typically be less than 500 μm.

Diatoms are suitable for colloidal suspensions in oil and are soluble in water. These characteristics, and the powder form described above enable diatoms to be added to the source material of various objects such as plastics, paper and metals. Diatoms are therefore suitable as additive to be embedded in a number of objects or to be arranged as an integral unit of the object. It is to be understood that this invention may be applied to any object in which the manufacturing process thereof includes the possibility of adding the diatoms to the source material and which manufacturing process further does not affect the integrity of the diatoms.

The invention provides for the growing of pure strains of diatoms each having an identical shape. A single or combination of different shapes of diatoms can be mixed together to serve as an identification code. For example, as shown in FIG. 3, the combination of four different diatoms can be accorded code “A” and code “B” respectively. In this manner a plurality of codes can be identified and recorded onto a database.

These codes, i.e. combinations of diatoms may be grown industrially as described above and embedded in an object during the manufacture thereof. Alternatively, the code/s may be secured to the object for example by a suitable adhesive or applied in a coating applied to the object.

The relevant codes may subsequently be identified against information contained in the database. This may include information regarding the identity, origin and kind of an object.

In use, a small sample or scraping of the object under analysis is treated to isolate the diatoms. In one embodiment of the invention, the sample or scraping is dissolved in a suitable solvent or chemical to isolate the diatoms.

In the case of diatoms exposed to the surface of a material or embedded in a translucent material, the object may remain intact and a simple image of the microscopic detail of the marked object is sufficient to be submitted for analysis to determine the code.

Once the diatoms are isolated from the object, the diatoms are identified and interpreted. This may be done by four different means, depending on the level of verification/analysis required.

The first manner is through the principle of conductivity. As silicon is a semi-conductor, an object such as paper embedded with diatoms should have altered conductivity. This will allow for a simple test to determine the presence of diatoms. In this instance, it is not necessary to isolate the diatoms from the object. It is only once the presence of diatoms is established that further investigation is required. The absence of a diatom is therefore indicative of a product not from a specific source and provides a result requiring no further investigation.

As mentioned above, a microscope can be used to visualize diatoms. There are a large number of microscopes which can be used in this regard, the most common of these being a light microscope, electron microscope or confocal microscope and lensless microscopes installed on a mobile device such as a smartphone. This method is convenient and allows for mobile and in field analysis i.e. outside of the laboratory environment.

A third method of reading and identifying diatoms is through the addition of synthetic dyes to the diatoms. Suitable stains could therefore be used to identify the presence of certain types of diatoms. In this regard, not only the shape, but the colour of the diatoms can be useful in providing means to provide a plurality of different diatoms to be arranged and identified as a code.

Diatoms can be chemically treated to alter their surface properties. One benefit of such treatment would be to make their incorporation into materials such as plastics more efficient.

Polymerase chain reaction (PCR) may also be used to read and identify codes of diatoms. As diatoms are biological organisms, they contain DNA. Standard DNA forensic techniques can therefore be employed (using PCR) to identify natural or synthetic DNA sequences within the diatoms.

The invention further includes employing software in the identification and interpretation of diatoms in a sample. Due to the highly reproducible nature of the photographic images from a microscope, views can be processed by software to identify and process diatoms present in the sample. Similar shape recognition technology is available for use in this regard. These may include technology similar to those used in facial recognition technologies.

It will be understood that the code may not only be confined to a random sequence to which a specific product or origin is assigned. It may provide yet further information regarding such object or the codes may be arranged to facilitate classification thereof. For example, a portion of the code may be used similar to a Dewey decimal number of the Dewey Classification system meaning products emanating from a certain source will all have a certain code element present. For example, all sources relating to engineering will include a code with the database element “622”. Similar type of industries may have code elements similar to that element “622”. For example, the codes “620 to 630” will reveal mining, engineering and other related industry sectors providing a convenient classification system in the database. This will also provide a convenient search and identification facility by using a specific code element to identify a source relating to a specific industry sector.

Determining the position of a symbol or character within a larger code is significant. For example, the 4 (four) digit code ABAB (from FIG. 3) could be confused with AABB. Therefore, secondary features of the diatoms such as size, colour under polarized filter etc. will encode the position of that digit within a code where required.

The invention will be useful in a number of applications as mentioned above. For example, the invention could be used as pharmaceutical tracers to identify “knock off” medicines. The invention may further be employed to identify an owner of an object such as a motor vehicle or other equipment. The invention may also be useful in important documents in which the source and authenticity is required to be upheld such as identity documents, birth and death certificates and money.

It will be appreciated that in terms of the invention, variations in details are possible without departing from the scope of this disclosure.

The description above is presented in the cause of providing what is believed to be the most useful and readily understandable description of the principles and conceptual aspects of the invention. In this regard, no attempt is made to show structural details of the invention in more detail than is necessary for a fundamental understanding of the invention. The words used here should be interpreted as words of description rather than words of limitation.

1. A system for marking and identifying an object comprising:
at least one bio-mineralised structure having a mean maximum diameter of less than 500 μm distinctively associated with the object;
identifying means for identifying said at least one bio-mineralised structure whilst being associated with the object; and
an output for providing data regarding said at least one bio-mineralised structure.

2. The system of claim 1, wherein the at least one bio-mineralised structure is integral with the object or provided as a source material, such as a fine powder, in the manufacturing of the object.

3. The system of claim 1, wherein the at least one bio-mineralised structure is provided as a plurality of different types of bio-mineralised structures each type having at least one distinctive characteristic and wherein each characteristic provides for a distinctive data output; and wherein a combination of different types of bio-mineralised structures are provided by the output as a code or codes.

4. The system of claim 1, wherein the data is provided by the output in the form of a symbol or character.

5. The system of claim 1, wherein the data or code is interpreted against a database to provide details of the manufacturer, information designating the kind of the object or history of the object including owner history and the transfer of ownership.

6. The system of claim 5 wherein, the output includes software to interpret the data or code against the information contained in the database.

7. The system of claim 1, wherein the output includes a display screen or printout.

8. The system of claim 3, wherein the respective distinctive characteristics of the bio-mineralised structures are expressed as the shape, size or colour of the bio-mineralised structures; and wherein the colour is adaptable by a synthetic dye applied to the bio-mineralised structures.

9. The system of claim 1, wherein the bio-mineralised structures are chemically treated to alter their surface properties to aid in binding or incorporation to materials such as plastics.

10. The system of claim 1, wherein the bio-mineralised structure includes any one or more of the group consisting of diatom, phytolith and coral sand or any combination thereof.

11. The system of claim 1, wherein the identifying means to include any one of the group consisting of:
a lensless microscope, light microscope, electron microscope and confocal microscope,
apparatus for measuring conductivity, and
apparatus for identifying natural or synthetic DNA sequences using polymerase chain reaction techniques.

12. The system of claim 11, wherein the microscopes further include a polarized filter to determine the colour of the bio-mineralised structure under said filter.

13. The system of claim 11, wherein the lensless microscope is installed on a mobile device such as a webcam, smartphone or tablet.

14. A method of marking and identifying an object comprising the steps of:
associating at least one distinctive bio-mineralised structure having a mean maximum diameter of less than 500 μm with the object;
identifying said at least one bio-mineralised structure; and
providing an output of data regarding said at least one bio-mineralised structure.

15. The method of claim 14, wherein the step of associating the at least one bio-mineralised structure with the object to further include the step of providing the at least one bio-mineralised structure as integral with the object or as a source material, such as a fine powder, in the manufacturing of the object.

16. The method of claim 14, wherein the at least one bio-mineralised structure is provided as a plurality of different types of bio-mineralised structures each type having at least one distinctive characteristic and wherein each characteristic provides for a distinctive data output; and wherein a combination of different types of bio-mineralised structures are provided by the output as a code or codes.

17. The method of claim 14, wherein the data is provided by the output in the form of a symbol or character.

18. The method of claim 14, wherein the data or code to be interpreted against a database to provide details of the manufacturer, information designating the kind of the object or history of the object including owner history and the transfer of ownership.

19. The method of claim 14, wherein the output includes a display screen or printout.

20. The method of claim 16, wherein the respective distinctive characteristics of the bio-mineralised structures are expressed as the shape, size or colour of the bio-mineralised structures; and wherein the colour is adaptable by a synthetic dye applied to the bio-mineralised structures.

21. The method of claim 14, wherein the step of associating at least one distinctive bio-mineralised structure with the object, includes the step of chemically treating the bio-mineralised structure to alter their surface properties to aid in binding or incorporation to materials such as plastics.

22. The method of claim 14, wherein the bio-mineralised structure includes any one or more of the group consisting of diatom, phytolith and coral sand or any combination thereof.

23. The method of claim 14, wherein the step of identifying the at least one bio-mineralised structure includes the step of any one of the group consisting of:
viewing the bio-mineralised structure through a microscope,
determining the conductivity of the object to detect the presence of the bio-mineralised structure,
employing polymerase chain reaction techniques to identify natural or synthetic DNA sequences within the bio-mineralised structure.

24. The method of claim 23, wherein is the step of viewing the bio-mineralised structure through a microscope includes the further step of using a polarized filter to determine the colour of the bio-mineralised structure under said filter.

25. The method of claim 24, wherein the microscope includes any one of a lensless microscope, light microscope, electron microscope and confocal microscope.

26. The method of claim 25, wherein the lensless microscope is installed on a mobile device such as a webcam, smartphone or tablet.

27. The method of claim 23, wherein the step of viewing the bio-mineralised structure through a microscope to include the further step of providing photographic images from the microscope to be processed by software to identify and interpret the bio-mineralised structure against the information contained in the database.

28. (canceled)

29. (canceled)
